(19) United States
(12) Patent Application Publication
(10) Pub. No.: US 2008/0247095 A1
(43) Pub. Date: Oct. 9, 2008

(54) Method and apparatus for temperature sensing in a hard disk drive

(75) Inventors: Dongman Kim, Campbell, CA (US); Eun Kyu Jang, San Jose, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/784,359

(22) Filed: Apr. 5, 2007

(51) Int. Cl. G11B 5/33

(52) U.S. Cl. 360/313

(57) ABSTRACT

A slider comprising a platinum layer including a first end and a second end, where slider temperature may be estimated based upon the platinum layer resistance. A head gimbal assembly including the slider. A head stack assembly including the head gimbal assembly. A preamplifier including an analog to digital converter for measuring the platinum layer resistance. An embedded circuit for electrically coupling to the head stack assembly to use the platinum layer to successively estimate slider temperature and estimate head disk impact events and maintain a head disk impact count. A hard disk drive including the slider and measuring the resistance of the platinum layer to estimate slider temperature and/or head disk impact events and increment and maintain a head disk impact count.

### TECHNICAL FIELD

This invention relates to temperature sensors in a hard disk drive, and in particular to a temperature sensor in the vicinity of the interface between a slider and a disk surface of a hard disk drive.

### BACKGROUND OF THE INVENTION

The typical temperature sensor used in a hard disk drive is a thermistor. These temperature sensors are not optimal temperature indicators for head-disk impacts. Previously, Giant Magneto-Resistive (GMR) read heads were used to indirectly monitor temperature changes within hard disk drives, but Tunneling Magneto-Resistive (TuMR) read heads have replaced GMR read heads, so this is no longer a viable option.

While the TuMR read heads provide for higher signal output, they have a nonlinear response to temperature, which makes them unsuitable for use as a temperature sensor. Furthermore TuMR sensors have additional problems as temperature sensors, because they tend to exhibit a wide range of Temperature Coefficient of Resistance (TCR) as well as substantial hysteresis of resistance to polarity. Additionally, the Flying height On Demand (FOD) element often employs a thermal-mechanical effect to deform the slider for altering the flying height, causing the TuMR read head to display time dependent behavior regarding resistance and experiences an annealing effect.

What is needed is a temperature sensor to detect head to disk impacts without using a GMR read head.

### SUMMARY OF THE INVENTION

Embodiments of the invention include a slider with a platinum layer, where the temperature of the slider may be estimated based upon the resistance of the platinum layer between a first end and a second end of the platinum layer. Embodiments of the invention also include a hard disk drive including at least one of these sliders.

The slider may further include a first line electrically coupled to the first end of the platinum layer and a second line, known herein as a temperature sensor line, electrically coupled to the second end of the platinum layer, where the temperature of the slider may be estimated based upon the resistance between the first line and the temperature sensor line. The platinum layer may be embedded into an undercoat region of the slider.

The first line may be used as a ground line in the slider. Measuring the resistance may be achieved by providing a voltage between the ground line and the temperature sensor line and measuring the current dissipation and/or providing a current between these lines and measuring the voltage drop. Ohm's Law is then used to create the resistance reading. Often, the current dissipation and/or the voltage drop will be reported by an Analog to Digital converter.

An example embodiment of the invention includes a head gimbal assembly in which the slider may electrically couple to the temperature sensor line through a temperature sensor trace included in a flexure finger.

An example embodiment of the invention includes a head stack assembly having a main flex circuit including an analog to digital converter electrically coupled to the temperature sensor trace of the flexure finger to provide at least one voltage measurement and/or at least one current measurement between the first line and the temperature sensor trace. The first line may act as a ground line for the slider and electrically couple to a ground plane of the main flex circuit.

The platinum layer may be used in the hard disk drive as a temperature sensor to create an estimate of the occurrence of a Head to Disk Impact event. Often these impact events are caused by a collision between the read-write head of the slider and a dust particle, which tend to heat the slider and are noted through by successively creating a voltage measurement and/or a current measurement, of the platinum layer and tracking the resulting temperature estimate based upon the resistance of the platinum layer to determine when the temperature jumps, indicating that the head disk impact event has occurred.

Creating the temperature estimate may further include steps for estimating the effect of a heater in the slider to create a heater effect estimate, and altering the temperature estimate based upon the heater effect estimate.

An example embodiment of the invention includes an embedded circuit electrically coupled to the head stack assembly, including a channel interface to provide the voltage measurement and/or the current measurement across the platinum layer to create a head disk impact event and increment a head disk impact count based upon the head disk impact event.

### BRIEF DESCRIPTION OF THE DRAWINGS

FIG. 1A shows a simplified schematic of an example embodiment of a slider, including a platinum layer with a first end and a second end for use in a hard disk drive as a temperature sensor at the slider;

FIG. 1B shows a refinement of the slider of FIG. 1A where the platinum layer is embedded in an undercoat region and the slider further includes a first line for electrically coupling to the first end of the platinum layer and a temperature sensor line for electrically coupling to the second end of the platinum layer;

FIG. 1C shows a refinement of the slider of FIG. 1B showing the first line being used as a ground line for the slider, as well as lines for the slider's write head, read head and flying height on demand heater;

FIG. 2A shows a simplified schematic of the slider of FIG. 1C;

FIG. 2B shows a cross section of a refinement of the sliders of previous Figures showing the heater, read-write head and the deformation region affected by the heater;

FIG. 3A shows a schematic of an example head gimbal assembly including a temperature sensor trace electrically coupled to the temperature sensor line of one of the sliders of the previous Figures;

FIG. 3B shows a side view of the head gimbal assembly of FIG. 3A;

FIG. 4A shows a schematic of an example head stack assembly including an analog to digital converter in a main flex circuit electrically coupling through the temperature sensor trace of the flexure finger to the platinum layer in the slider;

FIG. 4B shows a mechanical drawing of a partially assembled hard disk drive including the head stack assembly mounting through the actuator pivot to a disk base, the disk of the disk pack mounting through the spindle, and the mechanical effect of the fixed magnet interacting with the voice coil of the head stack assembly to pivot the head gimbal assembly over the disk surface to a lateral position near a track;

FIG. 5A shows a schematic of the head stack assembly of FIG. 4A where the main flex circuit containing a preamplifier including the analog to digital converter; and

FIG. 5B shows a schematic of an example hard disk drive with the head stack assembly electrically coupled to an embedded circuit further including a channel interface providing a voltage measurement or a current measurement of the platinum layer in the slider, which are used by a processor to create a head disk impact event and a head disk impact count.

### DETAILED DESCRIPTION

This application relates to temperature sensors in a hard disk drive, and in particular to a temperature sensor in the vicinity of the interface between a slider and a disk surface of a disk in a hard disk drive.

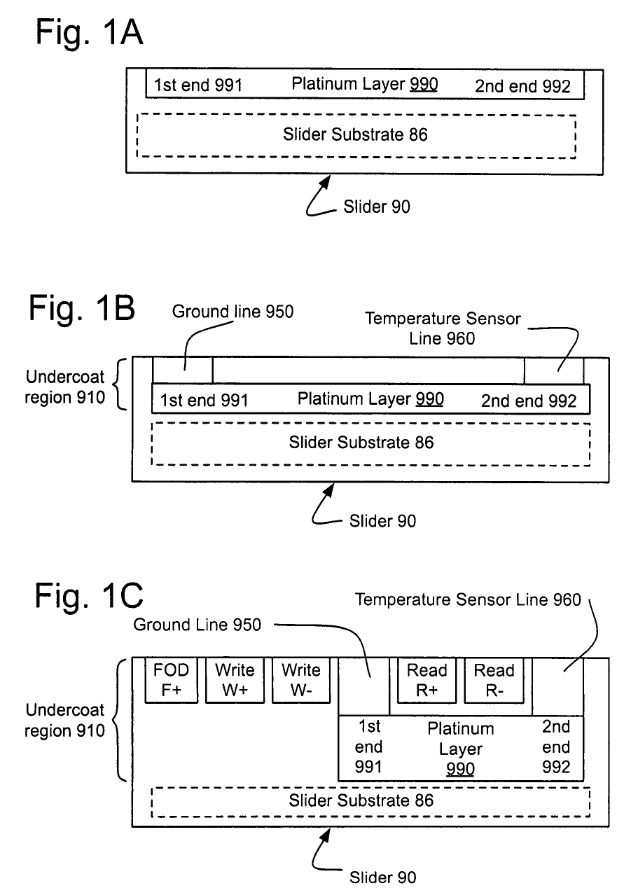

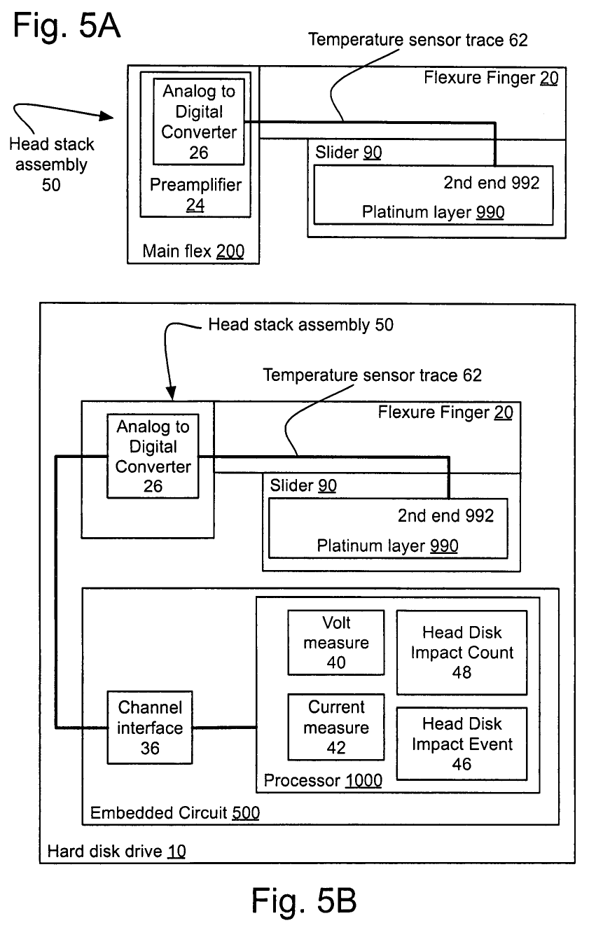

An example embodiment of the invention includes a slider 90, shown in FIG. 1A, where the temperature of the slider may be estimated based upon the electrical resistance of a platinum layer 990 between a first end 991 and a second end 992 of the platinum layer 990. An embodiment of the invention also includes a hard disk drive 10 which includes at least one of these sliders as shown in FIG. 5B.

The slider 90 may further include a first line, which is preferably but not necessarily a ground line and is hereafter referenced ground line 950, electrically coupled to the first end 991 of the platinum layer 990 and a second line, known herein as a temperature sensor line 960, electrically coupled to the second end 992 of the platinum layer 990. The temperature of the slider may be estimated based upon the resistance of the platinum layer 990 between the ground line 950 and the temperature sensor line as shown in FIG. 1B.

The platinum layer 990 may be embedded into an undercoat region 910 of the slider 90 as shown in FIGS. 1B and 1C.

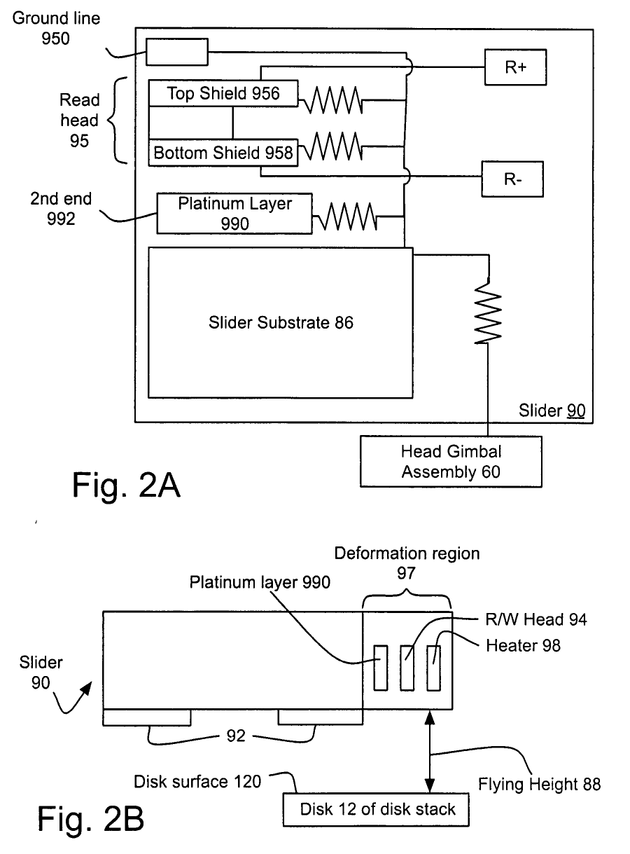

The use of the first line as the ground line 950 of the slider may include an electrical coupling to the slider substrate, which is shown in FIG. 2A. Note that in certain embodiments of the invention, the slider 90 may include more than one ground line 950, for instance, if the slider includes an amplifier, there may be more than one ground plane or line. For the sake of simplifying the discussion, the ground line 950 will be discussed as though there were only one ground line to a single ground plane formed on the slider substrate 86 as shown in FIG. 2A.

Measuring the resistance may be achieved by providing a voltage between the ground line 950 and the temperature sensor line 960 and measuring the current dissipation and/or providing a current between these lines and measuring the voltage drop. Ohm's Law is then used to create the resistance reading. The current dissipation and/or the voltage drop may be reported by an Analog to Digital converter 26 as a digital reading, and often as a fixed point or integer number. Ohm's law may be summarized as the voltage drop across a resistor is the current passing through it multiplied by its resistance, or the resistance is the voltage drop divided by the current.

The lines for differential signals referenced as R+ and R− of FIG. 1C may be electrically coupled to the top shield 956 and bottom shield 958 of the read head 95 as shown in FIG. 2A. The write differential signals referenced as W+ and W− may electrically couple to a write head, which is not shown.

The slider 90 may further include a vertical micro-actuator or heater 98 to alter the flying height 88 of a read-write head 94 of the slider over a rotating disk surface 120, as shown in FIG. 2B. When activated through the use of the Flying height On Demand (FOD) signal F+shown in FIG. 1C, the heater raises the temperature of the slider and stimulates a deformation region 97 to expand to alter the flying height 88 of the read-write head. During normal access operations the disk surface is rotated at several thousand revolutions per minute creating a wind interacting with the air bearing surface 92 to form an air bearing upon which the slider flies a short distance off the disk surface. Today this distance may be less than 10 nanometers making the reporting of head to disk impacts extremely useful.

The read head included in read-write head 94 of the slider 90 preferably does not employ the Giant Magneto-Resistive (GMR) effect. The read head preferably employs the Tunneling Magneto-Resistive effect (TuMR), but may also or alternatively employ other magnetic effects to read data from a track on the rotating disk surface.

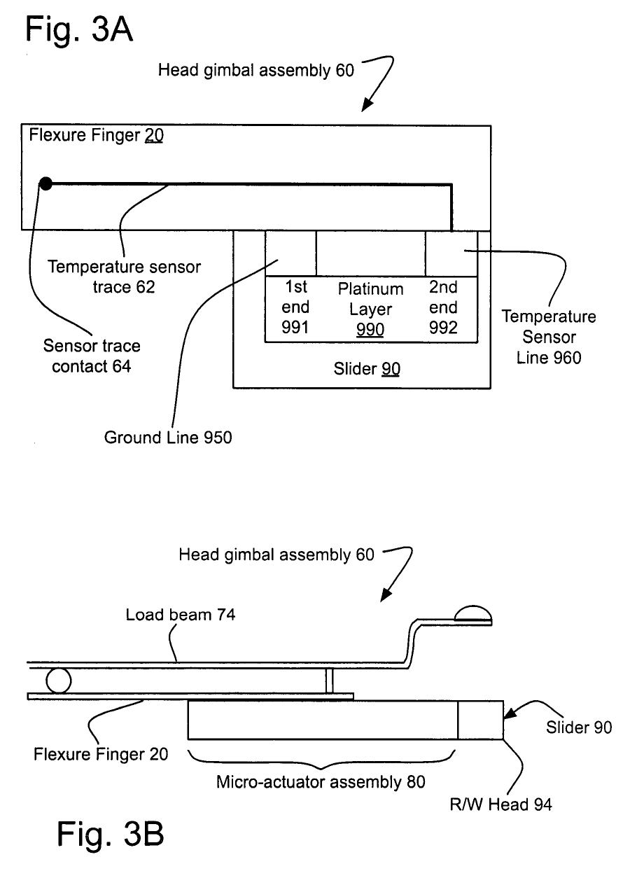

In a preferred embodiment of the head gimbal assembly 60, as seen in FIG. 3A, the temperature sensor line 960 communicates electrically through a temperature sensor trace 62, on flexure finger 20, which terminates in a sensor trace contact 64 which is adapted to electrically connect with further circuitry.

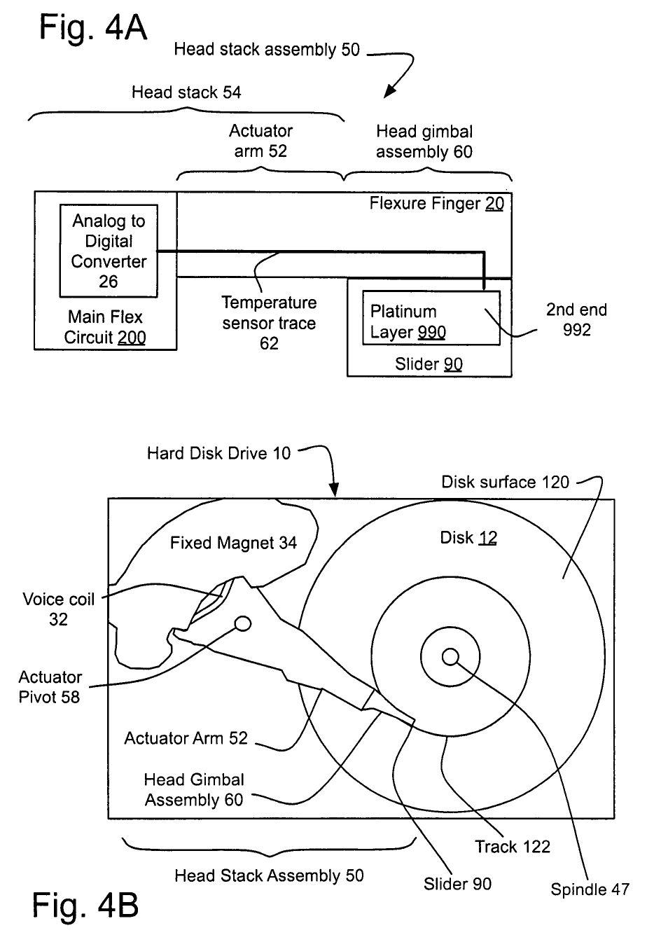

Referring to FIG. 3B, a load beam 74 can be seen coupled to the flexure finger 20. The head gimbal assembly may further include a micro-actuator assembly 80 coupled to the slider and used to alter the position of the read-write head 94 over a track 122 on the rotating disk surface 120 (seen in FIG. 4B). In certain embodiments, the micro-actuator assembly 80 may further aid in altering the flying height 88 (seen in FIG. 2B). The micro-actuator assembly 80 may employ any combination of the effects, including but not limited to: a piezoelectric effect, an electrostatic effect and a thermal-mechanical effect.

An example embodiment of a head stack assembly 50 may be seen in FIG. 4A, and comprises a main flex circuit 200 including an analog to digital converter 26 electrically coupled to the temperature sensor trace 62 of the flexure finger 20. The head stack assembly seen in FIG. 4A provides at least one voltage measurement 40 and/or at least one current measurement 42 between the ground line and the temperature sensor trace 62 through the platinum layer 990 as shown in FIG. 5B. The ground line 950 may be implemented as the ground line for the slider 90, which may be electrically coupled through the flexure finger 20 to the load beam 74 of FIG. 3B, which then electrically couples through the actuator arm 52 and the head stack 54 of FIG. 4B to the ground plane of the main flex circuit. The main flex circuit 200 may include a preamplifier 24 containing the analog to digital converter 26 as shown in FIG. 5A.

The platinum layer 990 is preferably used in the hard disk drive 10 as a temperature sensor, which is further used to create an estimate of the occurrence of a head to disk impact event 46, as shown in FIG. 5B, which will tend to heat the slider 90. These occurrences are noted by successively receiving the voltage measurement 40 and/or the current measurement 42 of the platinum layer 990 and tracking the resulting temperature estimate to determine when the temperature jumps, indicating that the head disk impact event 46 has occurred. With reference to FIG. 2B, these events (often referred to as thermal asperities) are often caused by a collision between the read-write head 94 of the slider 90 and a dust particle situated on the disk surface 120. Successive reception measurements can also be used, with jumps in them indicating a head disk impact event.

Using the model shown in FIG. 2A based upon the example embodiment of FIG. 1C, the resistance reading Rₜ may lead to creating the temperature estimate t through the use of a formula such as the following:

Rₜ=R₀(1+αt+βt²) (1)

Where R₀ is the nominal resistance of the platinum layer at base temperature T0, which may be set to 0° Centigrade (C.), then commonly accepted values for the non-constant coefficients are frequently given by

α=3.9083*10⁻³*° C.⁻¹ and (2)

β=−5.775*10⁻⁷*° C.⁻² (3)

This relationship is a quadratic equation, which is readily solved using standard algebraic techniques. In certain embodiments, the estimation of the temperature may be performed using a version of the following linear relationship, since the quadratic coefficient is nearly a hundred times smaller than the linear coefficient:

Rₜ=R₀(1+αt) (4)

Creating the temperature estimate t may further include steps for estimating the effect of a heater 98 on the slider 90 to create a heater effect estimate, and altering the temperature estimate based upon the heater effect estimate.

With reference to FIG. 5B, the embedded circuit 500 can electrically communicate with the head stack assembly 50 through a channel interface 36 to provide the voltage measurement 40 and/or the current measurement 42. A processor 1000 may receive the measurement to create a head disk impact event 46 and increment a head disk impact count 44 based upon the head disk impact event 46.

As used herein the processor 1000 may include at least one instance of a controller. As used herein, each controller receives at least one input, maintains and updates the value of at least one state and generates at least one output based upon at least one of the inputs and/or the value of at least one of the states. As used herein, the controller may include an instance of a finite state machine, and/or include an instance of an inference engine and/or an instance of a neural network and/or an instance of a computer directed by a program system including program steps or operations residing in a memory accessibly coupled via a buss to the computer. As used herein, a computer includes at least one instruction processor and at least one data processor, where each of the data processors is directed by at least one of the instruction processors.

As shown in FIG. 4B, the head stack assembly 50 rotatably couples through its actuator pivot 58 to laterally position the read-write head 94 of each slider 90 over a rotating disk surface 120 of at least one disk 12 of its disk pack during normal operation. Note that the disk may typically have two disk surfaces, either or both of which may be used to store data, and when so used, typically the hard disk drive has a separate slider in a separate head gimbal assembly for accessing the data of each disk surface. Also, as is well known, a disk stack may include one or more than one disk, with the head stack assembly often including more than one actuator arm in its head stack. In many embodiments two head gimbal assemblies may be coupled to an individual actuator arm. The main flex circuit 200 may share the analog to digital converter 48 (seen in FIGS. 4A and 5) between the multiple temperature sensor traces 62 of the head gimbal assemblies. The head disk impact count 48 may be separately maintained for each disk surface, for regions of the disk surface, and possibly for each track.

In normal data access operations, the hard disk drive 10 operates as follows: The disk 12 is spinning about the spindle 47 as shown in FIG. 4B, with the tracks typically forming concentric circles. The embedded circuit 500 of FIG. 5B stimulates the voice coil 32 with a time varying electrical signal, which induces a time varying electromagnetic field that interacts with the fixed magnet 34, which applies a force to the head stack assembly 50. The applied forces act through the actuator pivot 58 to swing the actuator arm 54 and its one or more head gimbal assembly 60 to position the read-write head 94 near a track 122 on the rotating disk surface 120. The hard disk drive may operate the platinum layer 990 as a temperature sensor during normal access operations when at least one slider 90 is flying close to the rotating disk surface.

The preceding embodiments provide examples of the invention and are not meant to constrain the scope of the following claims.

What is claimed is:

1. A slider for use in a hard disk drive, comprising:
a platinum layer comprising a first end and a second end;
wherein the temperature of said slider is estimated based upon a resistance of said platinum layer between said first end and said second end.

2. The slider of claim 1, wherein said platinum layer is embedded into an undercoat region of said slider.

3. The slider of claim 1, further comprising:
a first line electrically coupled to said first end; and
a temperature sensor line electrically coupled to said second end;
wherein said temperature of said slider is estimated based upon said resistance between said first line and said temperature sensor line.

4. The slider of claim 3, wherein said first line is used as a ground line.

5. A hard disk drive, comprising:
at least one slider, said slider comprises a platinum layer further comprising a first end and a second end; and
wherein the temperature of said slider is estimated based upon a resistance of said platinum layer between said first end and said second end.

6. The hard disk drive of claim 5, wherein said platinum layer is embedded in an undercoat region of said slider.

7. The hard disk drive of claim 5, wherein said slider further comprises:
a first line electrically coupled to said first end; and
a temperature sensor line electrically coupled to said second end;
wherein said temperature of said slider is estimated based upon said resistance between said first line and said temperature sensor line.

8. The hard disk drive of claim 7, wherein said first line is used as a ground line in said slider.

9. The hard disk drive of claim 7, further comprising a head gimbal assembly, wherein said head gimbal assembly comprises said slider coupled to a flexure finger, further comprising said temperature sensor line electrically coupled to a temperature sensor trace included in said flexure finger.

10. The hard disk drive of claim 9, further comprising a preamplifier coupling to said head gimbal assembly wherein said preamplifier comprises an analog to digital converter for electrically coupling to said temperature sensor trace for measuring said resistance between said first line and said temperature sensor trace.

11. The hard disk drive of claim 9, further comprising:
a head stack assembly, said head stack assembly comprising a main flex circuit electrically coupled to said head gimbal assembly, further comprising an analog to digital converter electrically coupled through said temperature sensor trace to said platinum layer to provide at least one measurement between said first line and said temperature sensor trace;
wherein said measurement is a member of the group consisting of a voltage measurement and a current measurement.

12. The hard disk drive of claim 11, further comprising an embedded circuit electrically coupled to said head stack assembly wherein said embedded circuit, comprises:
a channel interface electrically coupling to said main flex circuit to provide said measurement; and
a processor receiving said measurement to create a head disk impact estimate;
wherein said processor increments a head disk impact count based upon said head disk impact estimate.

13. A method of measuring a temperature of a slider comprising the steps:
providing a slider containing a platinum layer with a first end and a second end;
generating a resistance estimate of said platinum layer between said first end and said second end;
using said resistance estimate to create a temperature estimate of said slider.

14. The method of claim 13, wherein said first end is electrically coupled to a first line and said second end is electrically coupled to a temperature sensor trace in a flexure finger;
wherein the step generating said resistance estimate, comprises at least one member of the group consisting of the steps:
using an analog to digital converter to create a voltage measurement between said first line and said temperature sensor line for generating said resistance measurement; and
using said analog to digital converter to create a current measurement between said first line and said temperature sensor line for generating said resistance measurement.

15. The method of claim 14, further comprising the steps:
using said temperature estimate to create a head disk impact estimate; and
incrementing a head disk impact count based upon said head disk impact estimate.

16. An embedded circuit at least partly implementing the method of claim 15, comprising:
a channel interface electrically coupling to a main flex circuit containing said analog to digital converter to provide a measurement, wherein said measurement is a member of the group consisting of said voltage measurement and said current measurement; and
a processor receiving said measurement to create said head disk impact estimate;
wherein said processor increments said head disk impact count based upon said head disk impact estimate.

17. A head stack assembly at least partly implementing the method of claim 14, comprising:
an analog to digital converter electrically coupled through said temperature sensor trace to said platinum layer to provide at least one measurement between said first line and said temperature sensor trace;
wherein said measurement is a member of the group consisting of said voltage measurement and said current measurement.

18. The head stack assembly of claim 17, further comprising a main flex circuit comprising said analog to digital converter electrically coupled through said temperature sensor trace to said platinum layer to provide said measurement between said first line and said temperature sensor trace.

19. The head stack assembly of claim 18, wherein said main flex circuit further comprises: a preamplifier comprising said analog to digital converter for electrically coupling through said temperature sensor trace to said platinum layer to provide said measurement between said first line and said temperature sensor trace.
